(19) United States
(12) Patent Application Publication
(10) Pub. No.: US 2015/0316986 A1
(43) Pub. Date: Nov. 5, 2015

(54) APPARATUS AND METHOD TO REALIZE DYNAMIC HAPTIC FEEDBACK ON A SURFACE

(71) Applicant: SAMSUNG DISPLAY CO., LTD., Yongin-City (KR)

(72) Inventor: Jiuzhi Xue, Broomfield, CO (US)

(21) Appl. No.: 14/576,109

(22) Filed: Dec. 18, 2014

Related U.S. Application Data
(60) Provisional application No. 61/987,427, filed on May 1, 2014.

(51) Int. Cl. G06F 3/01; G06F 3/041

(52) U.S. Cl. CPC G06F 3/016; G06F 3/041

(57) ABSTRACT

A haptic device including a first electrode including a first sub-electrode configured to receive a first voltage, and a second sub-electrode configured to receive a second voltage, a second electrode overlapping with the first electrode, and a deformable layer located between the first and second electrodes and configured to deform in response to the applied first and second voltages, and to change a relative position of at least one of the first and second sub-electrodes with respect to the second electrode, wherein the first and second voltages are in reference to the second electrode.

### CROSS-REFERENCE TO RELATED APPLICATION

This application claims priority to and the benefit of U.S. Patent Application No. 61/987,427, filed on May 1, 2014, the entire content of which is incorporated herein by reference.

### FIELD

Embodiments of the present invention relate to a device for providing haptic feedback.

### BACKGROUND

In recent years, touchscreen devices have become commonplace as personal mobile devices, such as mobile phones, tablets, laptops, and the like have gained in popularity. In addition to portable devices, touchscreens are being used in industry and in places such as cars and kiosks where keyboard-and-mouse systems do not allow fast, intuitive or accurate interaction by the user with a display's content.

Touchscreen displays allow a user to interact with virtual objects shown on the display by recognizing user input, such as touching or tapping of the screen. However, any feedback to the user input is often only visual (e.g., highlighting of a virtual button pressed or initiating an animation, etc.), and touchscreen displays, which typically have smooth, rigid, glass surfaces, often lack any form of tactile feedback. This lack of tactile feedback makes for interactions that may feel “unnatural.” One practical effect of this is that users have a harder time typing on virtual keyboards displayed on smooth surfaces, and often experience more typing errors and slower typing speeds.

What is desired, then, is a haptic system that provides a richer and more natural feeling touch surface capable of providing tactile feedback in response to inputs by a user.

### SUMMARY

Aspects of embodiments of the present invention are directed toward an apparatus capable of providing haptic feedback in response to a touch event, and a method of driving the same. In some embodiments, the perceived smoothness or texture of a device surface may be controlled by the application of an electric field. In some embodiments, spatial variations in electric field applied to a device surface layer produce controllable physical deformations in the device surface that are detectable by a user of the device. In some embodiments, the device structure and the driving method enable the haptic feedback to a user to occur at a location corresponding to the touch event (e.g., the location of the user touch or tap of the device display screen).

Aspects of embodiments of the present invention are directed toward an electronic device employing a haptic device capable of providing haptic feedback in response to a touch event.

According to embodiments of the present invention, there is provided a haptic device including: a first electrode including a first sub-electrode configured to receive a first voltage, and a second sub-electrode configured to receive a second voltage; a second electrode overlapping with the first electrode; and a deformable layer located between the first and second electrodes and configured to deform in response to the applied first and second voltages, and to change a relative position of at least one of the first and second sub-electrodes with respect to the second electrode, wherein the first and second voltages are in reference to the second electrode.

The haptic device may further include: a first voltage source configured to apply the first voltage across the first sub-electrode and the second electrode; and a second voltage source configured to apply the second voltage across the first sub-electrode and the second electrode.

The deformable layer may be a uniform layer with substantially the same thickness across the haptic device in the un-deformed or quiescent state, and the first and second sub-electrodes may be formed on the same side of the deformable layer.

The first and second voltages may be alternating voltages that are out of phase.

The first voltage may be out of phase with the second voltage by about 180 degrees.

Amplitudes of the first and second voltages may be substantially the same.

The haptic device may further include a flexible protective layer on the first electrode.

The first and second electrodes may include transparent conductive material.

The first electrode may include flexible transparent conductive material.

The deformable layer may include at least one of an electro-active polymer and a nanostructured polymer electrolyte.

The haptic device may further include a substrate located below the first and second electrodes and the deformable layer.

In response to the applied first and second voltage sources, the first and second sub-electrodes of the first electrode may move toward or away from the substrate, while the second electrode may maintain a substantially fixed position relative to the substrate.

An amplitude of deformations of the deformable layer may be about 5 pm or greater.

Each of the first sub-electrodes may include one or more first features, and each of the second sub-electrodes may include one or more second features, wherein the first and second features are interlocked, electrically insulated from one another, and extend in generally a same direction.

According to some embodiments of the present invention there is provided a haptic surface device including: a plurality of first electrodes extending in a first direction; a plurality of second electrodes extending in a second direction crossing the first direction; a deformable layer located between the first and second electrodes; and a plurality of addressable haptic cells, a haptic cell of the plurality of addressable haptic cells formed at an overlap region of a first electrode of the plurality of first electrodes and a second electrode of the plurality of second electrodes, the first electrode including a first sub-electrode and a second sub-electrode, the haptic cell including: a first feature of the first sub-electrode configured to receive a first voltage; and a second feature of the second sub-electrode configured to receive a second voltage, wherein the first and second feature are interlocked and extend in generally a same direction, wherein the deformable layer is configured to deform in response to the applied first and second voltages, and to change a relative position of at least one of the first and second features with respect to the second electrode.

The haptic surface device may further include: a first voltage source configured to apply the first voltage across the first feature and the second electrode; and a second voltage source configured to apply the second voltage across the first feature and the second electrode.

The haptic surface device may further include: a first switch for coupling the first voltage source to the first feature; and a second switch for coupling the second voltage source to the first feature.

The haptic surface device may further include a third switch for coupling the first and second voltage sources to the plurality of second electrodes.

The first and second voltages may be alternating voltages that are out of phase.

According to some embodiments of the present invention there is provided an electronic device providing haptic feedback to a user in response to a user touch event, the electronic device including: a touch sensor configured to detect the user touch event; a haptic device on the touch sensor, the haptic device including: a first electrode including a first sub-electrode configured to receive a first voltage, and a second sub-electrode configured to receive a second voltage; a second electrode overlapping with the first electrode; and a deformable layer located between the first and second electrodes and configured to deform in response to the applied first and second voltages, and to change a relative position of at least one of the first and second sub-electrodes with respect to the second electrode, wherein the first and second voltages are in reference to the second electrode; and a controller coupled to the haptic device and configured to selectively apply the first and second voltages based on the detected the user touch event.

### BRIEF DESCRIPTION OF THE DRAWINGS

The accompanying drawings, together with the specification, illustrate example embodiments of the present invention, and, together with the description, serve to explain the principles of the present invention.

FIG. 1 is a cross-sectional view of a haptic device, according to some example embodiments of the present invention.

FIGS. 2A-2C are cross-sectional views of the haptic device of FIG. 1 while in operation, according to some example embodiments of the invention. FIG. 2A illustrates the haptic device while in a quiescent state, and FIGS. 2B-2C illustrate the haptic device in various deformed states, according to some example embodiments of the present invention.

FIGS. 3A-3B illustrate alternating voltages that are applied to the haptic device, according to some example embodiments of the present invention. FIG. 3C is a cross-sectional view of the haptic device of FIG. 1 responding to alternating electric fields of FIG. 3A applied to the first and second regions of the deformable layer, according to some example embodiments of the present invention. FIG. 3D is a conceptual visualization of the edges perceived by a user as a result of alternating deformations in the deformable layer, according to some example embodiments of the present invention.

FIG. 4A is a top view of a haptic device configured to provide controlled, local haptic feedback, according to an example embodiment of the present invention. FIG. 4B is a top view of an individually addressable haptic cell of the haptic device, according to some example embodiments of the present invention. FIGS. 4C-4E are top views of alternatively designed features of the haptic cell 420, according to some example embodiments of the present invention.

FIG. 5 illustrates an electronic device employing the haptic device to provide a touch-coordinate haptic response to a user, according to some example embodiments of the present invention.

### DETAILED DESCRIPTION

The detailed description set forth below in connection with the appended drawings is intended as a description of illustrative embodiments of a system and method for providing haptic feedback in accordance with the present invention, and is not intended to represent the only forms in which the present invention may be implemented or utilized. The description sets forth the features of the present invention in connection with the illustrated embodiments. It is to be understood, however, that the same or equivalent functions and structures may be accomplished by different embodiments that are also intended to be encompassed within the spirit and scope of the present invention. As denoted elsewhere herein, like element numbers are intended to indicate like elements or features. The terms “substantially,” “about,” and similar terms are used as terms of approximation and not as terms of degree, and are intended to account for the inherent deviations in measured or calculated values that would be recognized by those of ordinary skill in the art. Furthermore, as used herein, when a component is referred to as being “on” another component, it may be directly on the other component or one or more components may also be present therebetween. Moreover, when a component is referred to as being “coupled” to or “connected” to another component, it may be directly attached to the other component or one or more intervening components may be present therebetween. When the phrase “at least one of” is applied to a list, it is being applied to the entire list, and not to the individual members of the list.

According to some embodiments of the present invention, a haptic device provides haptic feedback (e.g., a tactile feedback) in response to a touch event. The touch event may be a physical touching of a user's finger on the haptic device. In some embodiments, the haptic device applies a spatially variant electrical field to a surface layer of the haptic device to produce controlled deformations in the surface layer and to alter the perceived smoothness or texture of surface of the device. For example, a surface friction felt by the user may be adjusted as desired. In some embodiments, the haptic device provides the haptic feedback at the touch location (e.g., the location of the user touch on the surface of the device). The haptic device may be employed in an electronic device (e.g., a portable electronic device, such as a smartphone or tablet) to provide information to the user through the sense of touch. For example, the haptic device may enable a user to physically sense (e.g., perceive or feel) the interaction with a virtual object (such as a tapping of a virtual key or activation of a virtual button) shown on the display of the electronic device.

In some embodiments, a viewable portion of the haptic device may be transparent and located on top of a display device or touch screen of an interactive display module.

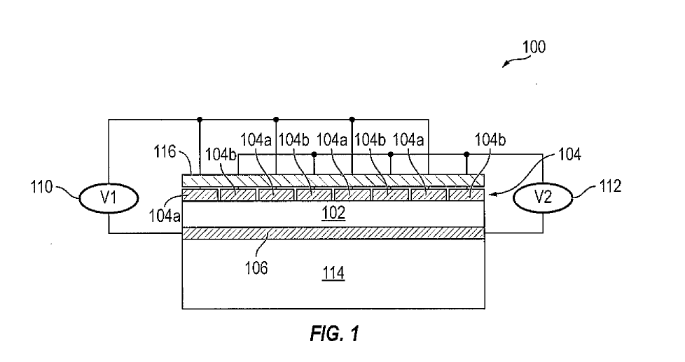

FIG. 1 is a cross-sectional view of a haptic device 100, according to some example embodiments of the present invention.

According to some embodiments, the haptic device 100 includes a deformable layer (e.g., an electrically deformable layer) 102 sandwiched between two opposing conductive electrodes, such as a first electrode 104 and a second electrode 106. In some embodiments, the first electrode 104 may be positioned above the deformable layer 102, while the second electrode 106 may be positioned below the deformable layer 102. Each of the first and second electrodes 104 and 106 may be in direct contact with a surface of the deformable layer 102 or may be separated from it by a respective intervening layer. In some embodiments, at least one electrode is patterned such that electrical field may be applied to the deformable layer 102 locally. For example, the first electrode 104 may include a plurality of first sub-electrodes 104a and second sub-electrodes 104b. The first sub-electrodes 104a may be electrically isolated from the second sub-electrodes 104b (e.g., through physical separation and/or an intervening insulating material). A first voltage source 110 may apply a voltage V1 across the first sub-electrodes 104a and the second electrode 106, and a second voltage source 112 may apply a voltage V2 across the second sub-electrodes 104b and the second electrode 106. By varying V1 and V2 with respect to one another, a spatially varying electric field may be created in the deformable layer 102. The sandwiched deformable layer 102 may be positioned on a substrate 114. The substrate 114 may be a display device or a touch screen that is part of an interactive display module. However, in some embodiments, the haptic device 100 may be physically separate from a display unit, as may be the case, for example, when the haptic device 100 is utilized in a tactile glove used in tandem with a virtual reality headset. The haptic device 100 may further include a protective layer (e.g., flexible protective coating) 116 to protect the haptic device 100 from being damaged (e.g., due to scratches or other environmental hazards).

The deformable layer 102 may include any suitable electrically deformable material, such as an electro-active polymer, a nanostructured polymer electrolyte, and/or the like. Examples of electro-active polymers may include poly(vinylidene fluoride), its copolymers, and terpolymers. Examples of nanostructured polymer electrolytes may include sulphonated block co-polymers. In some example embodiments, the thickness of the deformable layer 102 may be from about 50 μm to about 100 μm.

The first and second electrodes 104 and 106 may include transparent conductive material, such as indium tin oxide (ITO); flexible transparent conductive material, such as silver nanowires/nanofilms, metal meshes, electrically conducting carbon nanotubes, and suitable organic transparent conductive materials such as Poly(3,4-ethylenedioxythiophene) Polystyrene sulfonate (PEDOT:PSS); and/or the like. The transparent conductive material may also be a combination of the above listed materials, for example a metal mesh over a thin layer of organic transparent conductive material such as PEDOT:PSS. In some embodiments, the first and second electrodes 104 and 106 may not be transparent. The substrate 114 may include glass (e.g., sodalime and/or borosilicate glass) or plastic (e.g., polyethylene terephthalate (PET), polyimides, and/or polycarbonate), and/or the like. The protective layer 116 may be flexible and/or stretchable and may include polydimethylsiloxane (PDMS or silicone), its derivatives, polyurethane type material, and/or the like. For a given thickness, the wider the sub-electrodes, the lower their resistance may be, which may lead to a faster response time of the haptic device 100. In some embodiments, the width of each of the first and second sub-electrodes 104a and 104b may be equal or greater than 0.5 mm. The thickness of the first and second electrodes 104 and 106 may depend on the choice of conductive materials employed. For example, an organic transparent conductor, such as PEDOT:PSS, may have a thickness of about 20 nm to about 500 nm, and a metal mesh conductor may have a thickness of about 100 nm to about 2 μm with a width of about 0.5 μm to 5 μm. However, the present invention is not limited to the example values provided. For example, in other embodiments, the width of the sub-electrodes 104a and 104b may be less than 0.5 mm, and the first and second electrodes 104 and 106 may assume thickness values outside of the ranges provided for the example materials above.

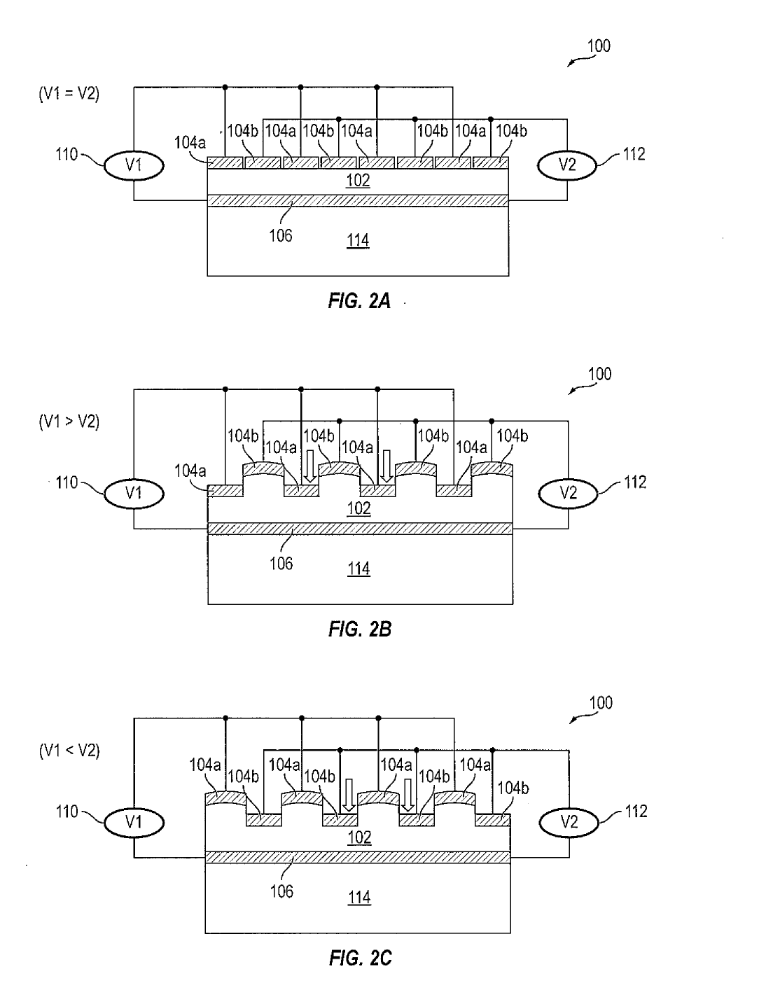

FIGS. 2A-2C are cross-sectional views of the haptic device 100 of FIG. 1 while in operation, according to example embodiments of the invention. FIG. 2A illustrates the haptic device 100 while in a quiescent state, and FIGS. 2B-2C illustrate the haptic device 100 in various activated or deformed states, according to some embodiments of the present invention. For purpose of illustration, in the following description, it is assumed that the deformable layer 102 has a substantially uniform thickness; however, embodiments of the inventions are not limited thereto and the concepts described herein also apply to embodiments in which the deformable layer 102 does not have a substantially uniform thickness.

According to some embodiments, when the first and second voltages sources 110 and 112 apply substantially equal voltages (e.g., when V1=V2=0 V), the haptic device 100 is in a quiescent state (e.g., dormant or inactive state) as a substantially uniform electric field (of, e.g., 0 V/m) is applied across the length of the deformable layer 102, which produces no deformations in the deformable layer 102. In the quiescent state, the outside surface (e.g., top surface) of the haptic device 100 may feel smooth to the touch.

In some embodiments, when voltages V1 and V2 are not the same, electric fields may be greater in areas corresponding to higher voltages leading to local deformations in the deformable layer 102. For example, when V1 is greater than V2 (as shown in FIG. 2B) the deformable layer 102 responds to the voltages by more shrinking (e.g., decreasing in thickness) in a first region corresponding to (e.g., under) the first sub-electrodes 104a, and less shrinking or even expanding (e.g., increasing in thickness) in a second region corresponding to (e.g., under) the second sub-electrodes 104b. In an example in which V2 is substantially zero, the expansion in the second region of the deformable layer 102 may be due to the fact that some material is pushed out of the first region due to the shrinkage in that region. Similarly, when V1 is less than V2 (as shown in FIG. 2C) the deformable layer 102 may expand (e.g., increase in thickness) in the first region and/or shrink (e.g., decrease in thickness) in the second region. In an example in which V1 is substantially zero, the expansion in the first region of the deformable layer 102 may be due to the fact that some material is pushed out of the second region due to the shrinkage in that region.

In some embodiments, the magnitude of the voltages V1 and V2 may be several thousand volts or a few volts, depending on, for example, the material of the deformable layer 102 as well as the desired displacement of the first and second plurality of sub-electrodes 104a and 104b. For example, electro-active polymers, such as poly(vinylidene fluoride) and its copolymers, may exhibit more than 7% deformation (e.g., deformation in thickness) when actuated at about 50 V/μm (volts per micro meter of deformable layer 102 thickness). Further, nanostructured polymer electrolytes, such as sulphonated block co-polymers, may exhibit 4% deformation when actuated at about 1 V/mm or less.

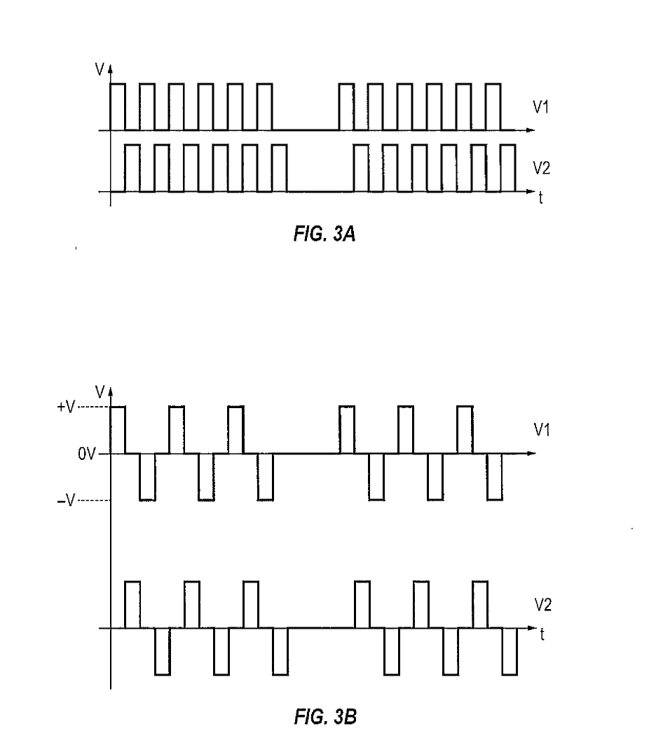

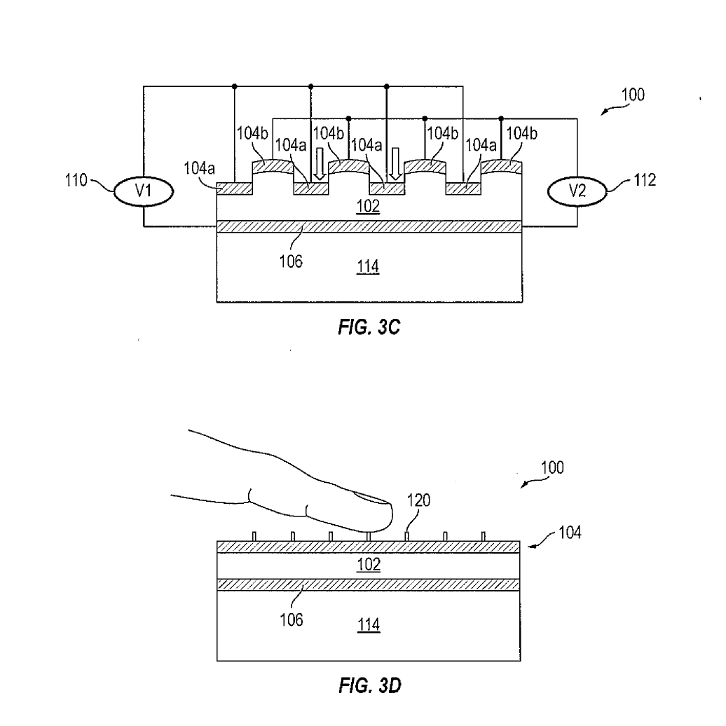

FIGS. 3A-3B illustrate alternating voltages V1 and V2 that are applied to the haptic device 100, according to some example embodiments of the present invention. FIG. 3C is a cross-sectional view of the haptic device 100 of FIG. 1 responding to alternating electric fields of FIG. 3A applied to the first and second regions of the deformable layer 102, according to example embodiments of the present invention. FIG. 3D is a conceptual visualization of the edges perceived by a user as a result of alternating deformations in the deformable layer 102, according to some embodiments of the present invention.

In some embodiments, the neighboring first and second regions of the deformable layer 102 are driven by electric fields (or voltages V1 and V2) that are out of phase as shown in FIG. 3A. For example, the voltages V1 and V2 applied by the first and second voltage sources 110 and 112 may be in the form of pulse trains that are out of phase (e.g., by 180°). The alternating voltages V1 and V2 may have any suitable alternating waveform, such as a sine wave, a square wave, or the like. While FIGS. 3A-3B illustrate near instantaneous rises and falls for alternating voltages V1 and V2, the voltages may have any suitable rate of change. Further, while FIGS. 3A-3B illustrate alternating voltages V1 and V2 as having amplitudes that are substantially the same, embodiments of the present invention are not limited thereto and the voltages V and V2 may have different amplitudes. Increasing the difference between the voltages V1 and V2 may result in decreasing (e.g., continuously decreasing) perceived tactile feedbacks; however, even when one of the voltages V1 and V2 is zero, there may be some perceived tactile feedback.

In some embodiments, voltage sequences V1 and V2 are DC balanced over time and have two or more voltage levels (e.g., as shown in FIGS. 3A-3B). For example, as shown in FIG. 3B, the voltages V1 and V2 may assume three values (e.g., −V, zero, and V) with one of V1 and V2 being at a non-zero value while the other is at zero.

When a user, for example, moves a finger on the surface of the haptic device 100, the vibrating structure changes the perceived friction and the user may perceive one or more “edges” 120 where two deforming out-of-phase regions (e.g., the first and second regions) meet, as shown in FIG. 3D. In some embodiments, when the alternating voltages V1 and V2 are in phase (e.g., have substantially zero phase difference), the surface of the haptic device 100 may be perceived as a smooth surface, and the haptic perception may disappear when V1 and V2 are substantially equal to 0 V. For alternating voltage V1 and V2 having non-zero amplitudes, the perceived edges 120 may become more prominent as the phase difference between the alternating voltages V1 and V2 increases and may be maximized as the phase difference approaches 180°. Edge perception may also increase as the amplitude of one or more of the voltages V1 and V2 is increased.

For example, when the alternating voltages V1 and V2 are in phases (e.g., have a phase difference equal to about 0°), a user (e.g., a user's finger tips) may perceive a vibrating surface when the deformation amplitude of the deformable layer 102 is about 30 μm or greater. In other embodiments, when the deformable layer 102 is driven by out-of-phase voltages alternating at certain frequencies (e.g., frequencies above about 5 Hz and below about 1 KHz), even when the amplitude of the deformation is small (e.g., about 5 μm), a user (e.g., a user's fingertip) may perceive one or more edges 120 as the surface of the deformable layer 102 is alternatively deformed.

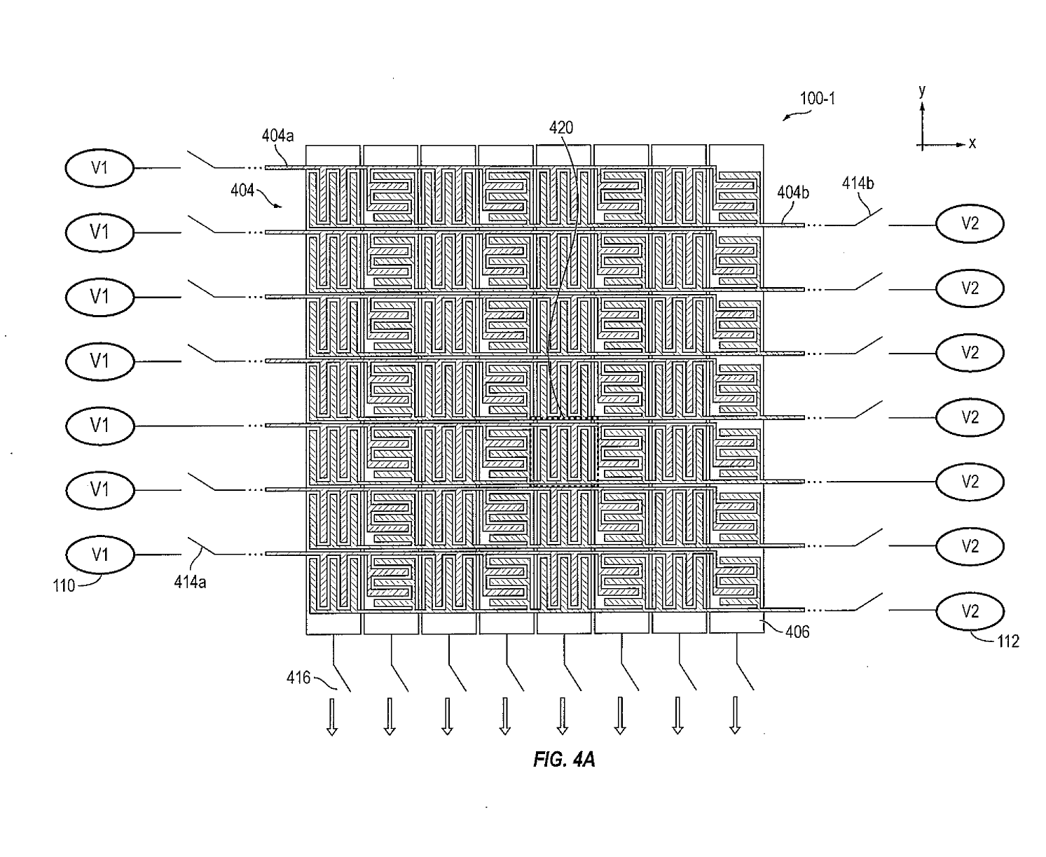

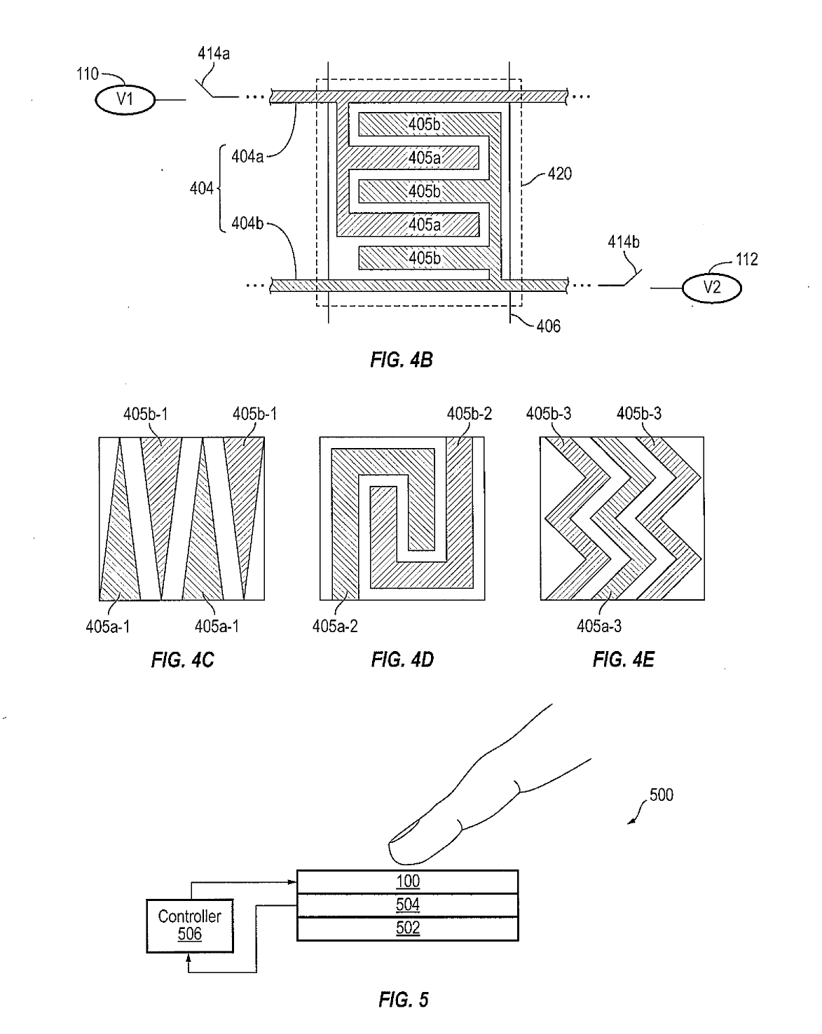

FIG. 4A is a top view of a haptic device 100-1 configured to provide controlled, local haptic feedback, according to an example embodiment of the present invention. FIG. 4B is a top view of an individually addressable haptic cell 420 of the haptic device 100-1, according to some example embodiments of the present invention. FIGS. 4C-4E are top views of alternatively designed features of the haptic cell 420, according to some example embodiments of the present invention.

According to some embodiments, the haptic device 100-1 includes a plurality of first and second electrodes (e.g., top and bottom electrodes) 404 and 406 and a deformable layer therebetween. In some embodiments, each of the first electrodes 404 includes first and second sub-electrodes 404a and 404b. The composition and operation of the first and second electrodes 404a and 404b, and the deformable layer may be substantially similar to those described above with respect to FIGS. 1-3D, and a description thereof may not be repeated here.

In some embodiments, the first and second sub-electrodes 404a and 404b include a -number of features (e.g., a number of protrusions or sub-stripes) and generally extend along a first direction (e.g., the X direction shown in FIG. 4A). The first and second sub-electrodes 404a and 404b may be individually addressable via the first and second switches 414a and 414b, respectively. In some embodiments, the switches 414a and 414b coupled to one row of sub-electrodes, such as 404a and 404b, are concurrently controlled (e.g., coupled to a same control signal). That is, turning on 414a automatically turns on 414b, and the voltages V1 and V2 are designed with phase relations as described in FIG. 3A-3B. In some embodiments, one or more first switches 414a couple (e.g., electrically connect) the first sub-electrodes 404a to one or more voltage sources including the first voltage source 110. In some embodiments, one or more second switches 414b couple the second sub-electrodes 406a to one or more voltage sources including the second voltage source 112. In some embodiments, the one or more first switches 414a may be coupled to the same voltage source, for instance, the first voltage source 110. Similarly, the one or more second switches 414b may be coupled to a same voltage source, for instance, the second voltage source 112.

In some embodiments, the second electrodes 406 may be in the form of stripes (e.g., bands) extending along a second direction (e.g., the Y direction shown in FIG. 4A). The second electrodes 406 may be addressed individually via a plurality of third switches 416, which may couple the second electrodes 406 to a reference voltage (e.g., ground voltage). In some example embodiments, the second electrodes 406 may be coupled to (e.g., directly coupled to) the reference voltage without the intervening third switches 416.

The first, second, and third switches 414a, 414b, and 416 may include electronic switches (such as field effect transistors), electromechanical switches, and/or the like.

The first and second electrodes 404 and 406 may be driven in a manner substantially similar to that described above with respect to 3A-3D.

The areas where the first and second electrodes 404 and 406 overlap form haptic cells 420 that may be individually addressed. The size of each of the haptic cells 420 may be adjusted to improve (e.g., optimize) user experience. In some example embodiments, the size of a haptic cell 420 is selected to correspond to (e.g., match) an approximate size of a user fingertip. For example, each side of the haptic cell 420 may be about 3 mm to about 10 mm in length (e.g., about 5 mm in length). The width of the stripes forming the second electrodes 406 and/or the area covered by the features of the first and second sub-electrodes 404a and 404b may be chosen to provide multiple perceived ridges or various suitable textures under a user's finger, and may, for example, be 0.5 mm in width and approximately as long as a length of a corresponding side of the haptic cell 420. The size of the haptic cells may determine the spatial resolution of the haptic response of the haptic device 100-1.

According to some embodiments, the features of each of the first and second sub-electrodes 404a and 404b may be in the form of one or more sub-stripes 405a or 405b extending in the first or second directions (e.g., X or Y directions, as shown in FIGS. 4A and 4B). In some example embodiments, the sub-stripes 405a and 405b may form prongs of two opposing and interlocked forks. In some embodiments, the sub-stripes 405a/405b of one haptic cell 420 may extend in a different direction than the sub-stripes 405a/405b of an adjacent haptic cell 420. In some embodiments, said sub-strip extension directions may alternate from the first direction to the second direction. For example, the extension directions may alternate according to a checkerboard pattern (as, e.g., shown in FIG. 4A). However, embodiments of the present invention are not limited thereto and any other suitable extension direction pattern may be adopted. By varying the extension direction of the sub-stripes 405a/405b of the haptic cells 420, one may be able to create different perceived textures on the surface of the haptic device 100-1.

As shown in FIGS. 4C-4E, the features of the first and second sub-electrodes 404a and 404b are not limited to the rectangular sub-stripes 405a/b of FIG. 4B, and may assume any suitable shape and form. For example, the features may form triangular teeth 405a-1 and 405b-1 (as shown in FIG. 4C), spirals 405a-2 and 405b-2 (as shown in FIG. 4D), zig-zag or saw-tooth prongs 405a-3 and 405b-3 (as shown in FIG. 4E), or any other suitable shape. In some embodiments, one or more haptic cells 420 of the haptic device 100-1 may have different feature patterns. As shown in FIGS. 4B-4E, the features of the first sub-electrodes 404a may be shaped to fit together (e.g., interlocked) with the features of the second sub-electrodes 404b without making physical contact with each other, so as to remain electrically insulated from one another.

While the haptic cells 420 shown in FIG. 4A cover a rectangular area (e.g., square area), embodiments of the present invention are not limited thereto. For example, the haptic cells 420 may be organized in any suitable way to cover a surface having any desired shape (such as a diamond shape), and the spatial density of cells may vary as desired.

In some embodiments, the haptic device 100-1 may be employed in a display device having a touch screen, which may be positioned under the haptic device 100-1. In such embodiments, when the user interacts with (e.g., touches) the display device, a controller may toggle (e.g., close) the switches 414a/b and 416 to activate (or drive) one or more haptic cells 420 corresponding to the interaction location, by coupling the first and second electrodes 404 and 406 associated with the one or more haptic cells 420 to the first and second voltage sources 110 and 112. As such, a user may perceive a haptic feedback at the interaction location. In some embodiments, for example when switches 416 are activated simultaneously, in addition to the haptic feedback directly over the touch interaction locations, the haptic feedback may be provided in areas of the display device different from the interaction location (which may also be referred to as “ghost locations”).

FIG. 5 illustrates an electronic device 500 employing the haptic device 100 to provide a touch-coordinate haptic response to a user, according to some embodiments of the present invention.

According to some embodiments, the electronic device 500 is a touch-sensitive display device, which includes display pixels 502 for displaying an image, a touch sensor 504 for detecting touch interactions with the image being displayed, and the haptic device 100 for providing haptic feedback to the user. In some embodiments, the touch sensor 504 may be positioned between the display pixels 502 and the haptic device 100. The touch sensor 504 and the haptic device 100 may include substantially transparent material so as not to hinder visibility of the image being displayed by the display pixels 502. In some embodiments, the touch sensor 504 relays information regarding the user touch interaction (e.g., the location of the user touch) to a controller 506, which, in turn, controls the haptic device 100. In some embodiments, when the user activates a button displayed by the electronic device 500 by, for example, pressing on the screen of the electronic device (e.g., pressing on a top surface of the haptic device 100), the touch sensor 504 detects the user press and its location and passes that information to the controller 506. The controller 506 may then activate a region (e.g., one or more haptic cells) of the haptic device 100 corresponding to the location of the user touch, thus changing the perceived texture of the surface of the haptic device 100 (or providing force feedback) under the user's finger and providing the user with a haptic feedback response. As such, the haptic device 100 may give the user the perception of interacting with a real tangible button, rather than simply a virtual button.

In some embodiments, the touch sensor 504 is pressure sensitive and the controller 506 is capable of adjusting the haptic response to correspond to the measured force exerted by the user on the surface of the haptic device 100. For example, the controller 506 may increase the frequency or amplitude of the alternating voltages applied to the features of the haptic cells corresponding to the location of a user's finger, as the user's finger applies more pressure/force.

While the haptic device 100, the display pixels 502, the touch sensors 504, and controller 506 have been shown as separate elements in FIG. 5, the separation may only be conceptual, as one or more of the aforementioned elements may be physically integrated together as one unit. For example, the haptic device 100 and the display pixels 502 may share one or more of the same substrates.

While this invention has been described in detail with particular references to illustrative embodiments thereof, the embodiments described herein are not intended to be exhaustive or to limit the scope of the invention to the exact forms disclosed. Persons skilled in the art and technology to which this invention pertains will appreciate that alterations and changes in the described structures and methods of assembly and operation can be practiced without meaningfully departing from the principles, spirit, and scope of this invention, as set forth in the following claims and equivalents thereof.

What is claimed is:

1. A haptic device comprising:
a first electrode comprising a first sub-electrode configured to receive a first voltage, and a second sub-electrode configured to receive a second voltage;
a second electrode overlapping with the first electrode; and
a deformable layer located between the first and second electrodes and configured to deform in response to the applied first and second voltages, and to change a relative position of at least one of the first and second sub-electrodes with respect to the second electrode,
wherein the first and second voltages are in reference to the second electrode.

2. The haptic device of claim 1, further comprising:
a first voltage source configured to apply the first voltage across the first sub-electrode and the second electrode; and
a second voltage source configured to apply the second voltage across the first sub-electrode and the second electrode.

3. The haptic device of claim 1, wherein the first and second sub-electrodes are on a same side of the deformable layer, and the deformable layer is substantially uniform in thickness in an un-deformed state.

4. The haptic device of claim 1, wherein the first and second voltages are alternating voltages that are out of phase.

5. The haptic device of claim 4, wherein the first voltage is out of phase with the second voltage by about 180 degrees.

6. The haptic device of claim 4, wherein amplitudes of the first and second voltages are substantially the same.

7. The haptic device of claim 1, further comprising a flexible protective layer on the first electrode.

8. The haptic device of claim 1, wherein the first and second electrodes comprise transparent conductive material.

9. The haptic device of claim 1, wherein the first electrode comprises flexible transparent conductive material.

10. The haptic device of claim 1, wherein the deformable layer comprises at least one of an electro-active polymer and a nanostructured polymer electrolyte.

11. The haptic device of claim 1, wherein the second electrode is coated on a substrate, the substrate being rigid.

12. The haptic device of claim 1, wherein the second electrode is coated on a substrate, the substrate being an electrooptic device.

13. The haptic device of claim 11, wherein the substrate is transparent.

14. The haptic device of claim 11, wherein an amplitude of deformations of the deformable layer is about 5 pm or greater.

15. The haptic device of claim 11, wherein each of the first sub-electrodes comprises one or more first features, and each of the second sub-electrodes comprises one or more second features, wherein the first and second features are interlocked, electrically insulated from one another, and extend in generally a same direction.

16. A haptic surface device comprising:
a plurality of first electrodes extending in a first direction;
a plurality of second electrodes extending in a second direction crossing the first direction;
a deformable layer located between the first and second electrodes; and
a plurality of addressable haptic cells, a haptic cell of the plurality of addressable haptic cells formed at an overlap region of a first electrode of the plurality of first electrodes and a second electrode of the plurality of second electrodes, the first electrode comprising a first sub-electrode and a second sub-electrode, the haptic cell comprising:
a first feature of the first sub-electrode configured to receive a first voltage; and
a second feature of the second sub-electrode configured to receive a second voltage,
wherein the first and second feature are interlocked and extend in generally a same direction,
wherein the deformable layer is configured to deform in response to the applied first and second voltages, and to change a relative position of at least one of the first and second features with respect to the second electrode.

17. The haptic surface device of claim 16, further comprising:
a first voltage source configured to apply the first voltage across the first feature and the second electrode; and
a second voltage source configured to apply the second voltage across the first feature and the second electrode.

18. The haptic surface device of claim 17, further comprising:
a first switch for coupling the first voltage source to the first feature; and
a second switch for coupling the second voltage source to the first feature.

19. The haptic surface device of claim 17, further comprising:
a third switch for coupling the first and second voltage sources to the plurality of second electrodes.

20. The haptic surface device of claim 16, wherein the first and second voltages are alternating voltages that are out of phase.

21. The haptic surface device of claim 16, wherein the second electrode is coated on a substrate.

22. An electronic device providing haptic feedback to a user in response to a user touch event, the electronic device comprising:
a touch sensor configured to detect the user touch event;
a haptic device on the touch sensor, the haptic device comprising:
a first electrode comprising a first sub-electrode configured to receive a first voltage, and a second sub-electrode configured to receive a second voltage;
a second electrode overlapping with the first electrode; and
a deformable layer located between the first and second electrodes and configured to deform in response to the applied first and second voltages, and to change a relative position of at least one of the first and second sub-electrodes with respect to the second electrode,
wherein the first and second voltages are in reference to the second electrode; and
a controller coupled to the haptic device and configured to selectively apply the first and second voltages based on the detected the user touch event.
